(19) United States
(12) Patent Application Publication
(10) Pub. No.: US 2025/0269716 A1
(43) Pub. Date: Aug. 28, 2025

(54) VEHICLE LID STRUCTURE

(71) Applicant: MORIROKU TECHNOLOGY COMPANY, LTD., Tokyo (JP)

(72) Inventor: Takuya Kurokawa, Tokyo (JP)

(21) Appl. No.: 19/058,433

(22) Filed: Feb. 20, 2025

(30) Foreign Application Priority Data
Feb. 28, 2024 (JP) 2024-029033

(51) Int. Cl. B60K 15/05; B60L 53/16

(52) U.S. Cl. CPC B60K 15/05; B60L 53/16; B60K 2015/053

(57) ABSTRACT

A vehicle lid structure includes: a main body member that is able to block an opening formed on an exterior surface visible from the outside; and a base material which supports the main body member and is swingable about a shaft member located behind the exterior surface. The base material has an edge cover portion which covers an edge of the main body member from the rear side. When viewed from a direction along the exterior surface based on a closed state, a surface of the edge cover portion is inclined to approach the opening as it goes from a center of the opening toward an edge of the opening.

### FIELD OF THE INVENTION

The present invention relates to a vehicle lid structure.

### BACKGROUND

A fuel filler port and a charging port of a vehicle are often designed to be opened and closed using a lid device called a fuel lid. A conventional technique related to such a lid device is disclosed in Japanese Patent Application Laid-Open No. 2019-98807. The lid device is configured to open and close an opening in a vehicle body by using a swingable lid.

Incidentally, in a lid device in which a design surface is exposed to the outside, it is anticipated that a non-occupant may improperly pry open the lid using a tool or the like. There is room for improvement in terms of prying the lid open.

An object of the present disclosure is to provide a vehicle lid structure having a lid that is difficult to pry open.

### SUMMARY

According to the present disclosure, there is provided a vehicle lid structure including: a main body member that is able to block an opening formed on an exterior surface visible from the outside; and a base material which supports the main body member and is swingable about a shaft member located behind the exterior surface, wherein the base material has an edge cover portion which covers an edge of the main body member from the rear side, and wherein when viewed from a direction along the exterior surface based on a closed state, a surface of the edge cover portion is inclined to approach the opening as it goes from a center of the opening toward an edge of the opening.

According to the present disclosure, it is possible to provide a vehicle lid structure having a lid that is difficult to pry open.

### BRIEF DESCRIPTION OF THE DRAWINGS

FIG. 1 is a front view of a lid device that adopts a vehicle lid structure according to an embodiment;

FIG. 2 is a cross-sectional view taken along line 2-2 of FIG. 1;

FIG. 3 is an enlarged perspective view of an edge cover portion shown in FIG. 2; and

FIG. 4 is an enlarged view of part 4 of FIG. 2.

### DETAILED DESCRIPTION

An embodiment of the invention will be described below with reference to the accompanying drawings. The embodiment shown in the accompanying drawings are merely examples of the invention, and the invention is not limited to this embodiment.

### Embodiment

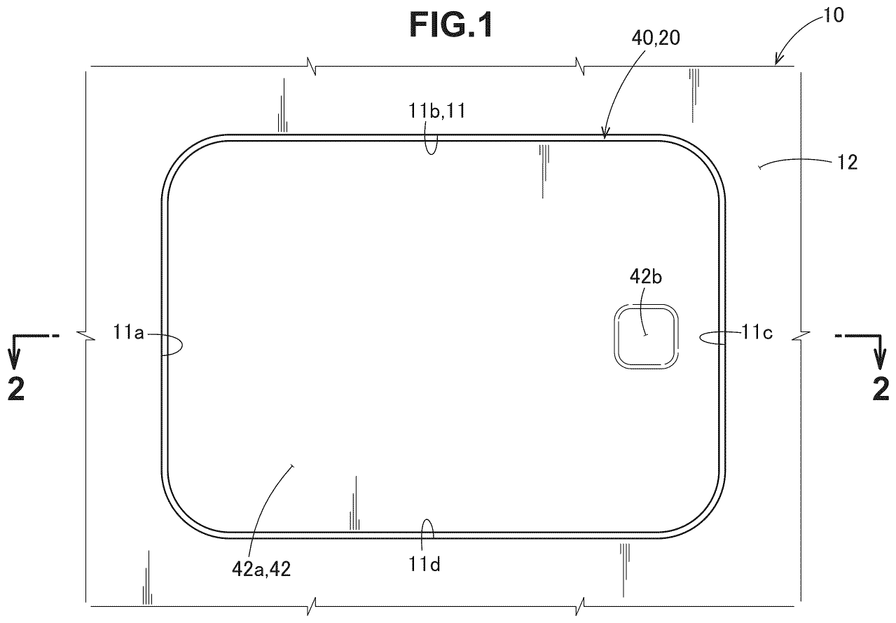

A description will be made with reference to FIG. 1. FIG. 1 shows a vehicle lid device 20 (hereinafter, referred to as “lid device 20”) using a vehicle lid structure. The lid device 20 is, for example, a fuel lid that opens and closes a fuel filler port or a charging port. The lid device 20 opens and closes an opening 11 provided in an exterior member 10 provided on the vehicle body.

The exterior member 10 is a component made of resin. The exterior member 10 is, for example, a front grille provided at the front of the vehicle. The surface of the exterior member 10 facing the exterior of the vehicle is referred to as an “exterior surface 12” that is visible from the outside. The exterior member 10 has the opening 11 that is a substantially rectangular hole.

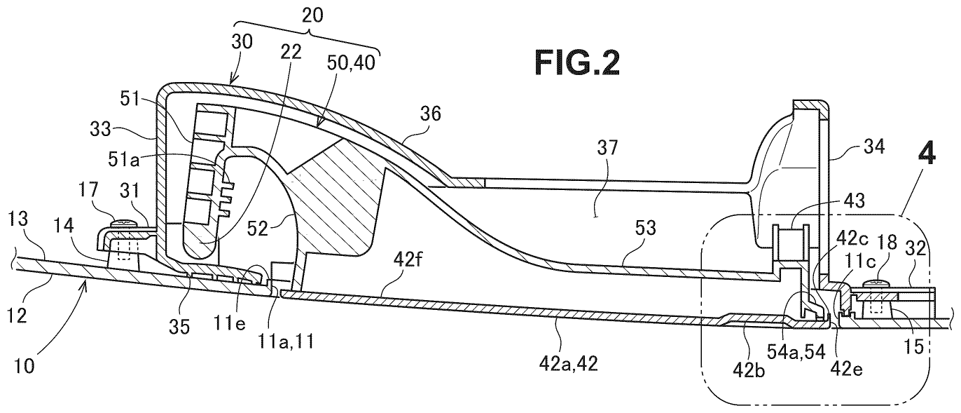

A description will be made with reference to FIG. 2. A plurality of bosses 14 and 15 for fixing the lid device 20 are formed on an exterior rear surface 13 which is the rear surface of the exterior surface 12. The lid device 20 is fixed to the bosses 14 and 15 by screw fastening members 17 and 18 formed by screws.

The lid device 20 includes a support member 30 that is fixed to the rear side of the exterior member 10, a shaft member 22 which is a shaft supported by the support member 30, and a lid 40 which is supported by the shaft member 22 and is able to open and close the opening 11.

A description will be made with reference to FIG. 1. The edges of the substantially rectangular opening 11 correspond to the respective sides, and are referred to as a first edge portion 11a, a second edge portion 11b, a third edge portion 11c, and a fourth edge portion 11d, respectively, from the edge on the left side in the figure.

A description will be made with reference to FIG. 1 and FIG. 2. The first edge portion 11a and the third edge portion 11c extend substantially in parallel in the extension direction of the shaft member 22, and the second edge portion 11b and the fourth edge portion 11d extend substantially perpendicularly to the extension direction of the shaft member 22. The first edge portion 11a is located at a position closer to the shaft member 22 than the third edge portion 11c. The third edge portion 11c is located at a position farther from the shaft member 22 than the first edge portion 11a.

A description will be made with reference to FIG. 2. In the bosses 14 and 15, the boss 14 formed in a position closer to the first edge portion 11a is referred to as the first boss 14, and the boss 15 formed in a portion closer to the third edge portion 11c is referred to as the second boss 15.

The screw fastening members 17 and 18 may be any type of screw, such as a machine screw, a tapping screw, a cap bolt, or a bolt. In the screw fastening members 17 and 18, the screw fastening member 17 fastened to the first boss 14 is referred to as the first fastening member 17, and the screw fastening member 18 fastened to the second boss 15 is referred to as the second fastening member 18.

The support member 30 is configured as an integrally molded article. The support member 30 is a substantially box-shaped member with an opening at the portion where the lid 40 is attached. The support member 30 has a first fixing portion 31 which is fixed to the first boss 14, a second fixing portion 32 which is fixed to the second boss 15, a first side wall 33 which is connected to the end portion of the first fixing portion 31 and extends in a direction away from the exterior member 10, a second side wall 34 which is connected to the end portion of the second fixing portion 32 and extends in a direction away from the exterior member 10, a support member contact portion 35 which extends along the rear surface of the exterior member 10 from an end portion (one end) of the first side wall 33 closer to the exterior member 10 and comes into contact with the exterior rear surface 13 of the exterior member 10, a rear wall 36 which connects an end portion (the other end) of the first side wall 33 farther from the exterior member 10 to an end portion (the other end) of the second side wall 34 farther from the exterior member 10, a bottom portion 37 which closes the lower end, and a ceiling portion (not shown) which faces the bottom portion 37 and closes the upper end. The support member contact portion 35 extends along the exterior rear surface 13 from the first side wall 33 toward the edge of the opening 11.

The lid 40 has a base material 50 which is supported by the shaft member 22, a main body member 42 which is supported by the base material 50 and is exposed to the outside of the vehicle, and a held portion 43 which extends from the tip of the base material 50 toward the support member 30 and is held by a locking device (not shown) in a fully closed state.

The base material 50 is configured as a single resinous molded product. The base material 50 has a lid contact portion 51 which extends in the radial direction from the shaft member 22 and is able to contact the support member 30 in a fully open state, a connection portion 52 which connects the tip of the lid contact portion 51 to the end portion of the main body member 42 on the side of the first edge portion 11a, a space forming portion 53 which is provided along the rear surface of the main body member 42 and forms a space together with the main body member 42, and an edge cover portion 54 which is formed at the tip of the end portion of the space forming portion 53 and covers an edge 42e from the rear side of the main body member 42.

The lid contact portion 51 is provided with a lid contact portion rib 51a which comes into contact with the support member 30 in a fully open state and increases the strength of the lid contact portion 51.

The connection portion 52 is formed in a curved shape not to come into contact with the first edge portion 11a when displacing from the fully closed state to the fully open state.

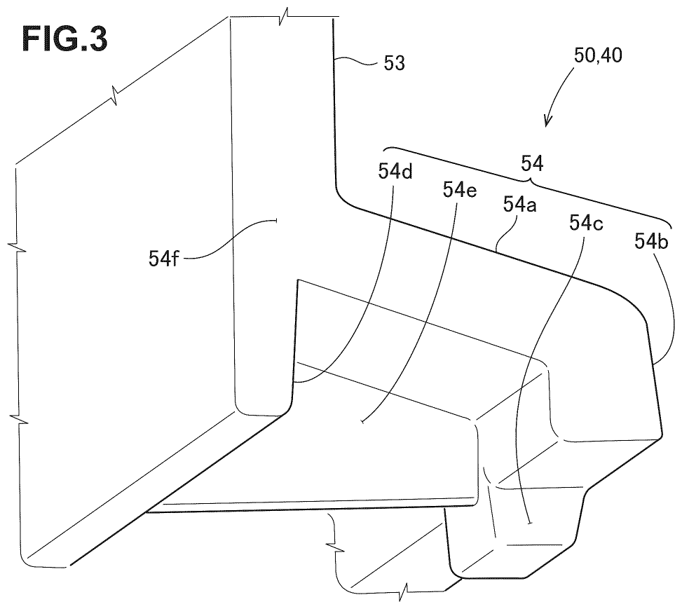

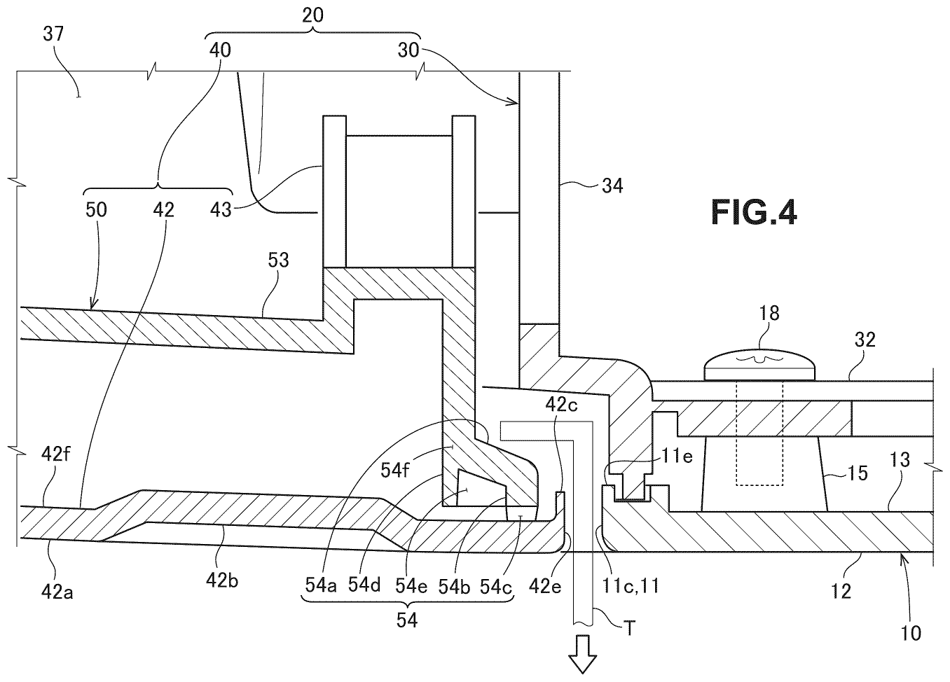

A description will be made with reference to FIG. 3 and FIG. 4. The edge cover portion 54 has a plate-shaped portion 54a which is formed in a tapered shape to gradually approach the edge 42e of the main body member 42 from the tip of the space forming portion 53, an edge cover base portion 54b which extends from the tip of the plate-shaped portion 54a toward a rear surface 42f of the main body member 42, a positioning protrusion 54c which protrudes from the tip of the edge cover base portion 54b and determines the relative positions of the main body member 42 and the base material 50, an edge cover portion rib 54d (rib 54d) which extends from a base end 54f (a boundary between the space forming portion 53 and the plate-shaped portion 54a) of the plate-shaped portion 54a toward the rear surface 42f of the main body member 42, and an edge cover connection portion 54e (connection portion 54e) which connects the plate-shaped portion 54a, the edge cover base portion 54b, and the edge cover portion rib 54d.

Furthermore, when the positioning protrusion 54c comes into contact with the rear surface 42f, the edge cover base portion 54b is separated from the rear surface 42f. The edge cover portion 54 may not be provided with the positioning protrusion 54c. When the positioning protrusion 54c is not provided, the edge cover base portion 54b comes into contact with the rear surface 42f. Further, the edge cover portion rib 54d does not necessarily come into contact with the rear surface 42f regardless of the presence or absence of the positioning protrusion 54c.

A description will be made with reference to FIG. 1 and FIG. 2. The main body member 42 is configured as an integrally molded article. A lid design surface 42a which is a surface exposed to the outside of the vehicle in the main body member 42 is substantially continuous to the exterior surface 12. The lid design surface 42a has a substantially rectangular shape along the opening 11.

A part of the lid design surface 42a may be formed as a recess 42b that is slightly recessed compared to other parts. Accordingly, an operator can easily recognize the part to be operated by the operator.

A main body protrusion 42c protrudes from the edge 42e of the main body member 42 along the side surface of the edge cover portion 54.

An opening protrusion 11e which protrudes toward the inside of the vehicle is integrally formed at the edge of the opening 11.

The vehicle lid structure adopted in the lid device 20 (lid 40) described above will be summarized below.

A description will be made with reference to FIG. 2. Firstly, the vehicle lid structure includes the main body member 42 that is able to block the opening 11 formed on the exterior surface 12 which is visible from the outside and the base material 50 which supports the main body member 42 and is swingable about the shaft member 22 located behind the exterior surface 12. The base material 50 has the edge cover portion 54 which covers the edge of the main body member 42 from the rear side. When viewed from a direction along the exterior surface 12 based on the closed state, the surface of the edge cover portion 54 is inclined to approach the opening 11 as it goes from the center of the opening 11 toward the edge of the opening 11.

A description will be made with reference to FIG. 4. Since the surface of the edge cover portion 54 is inclined, the tool T is less likely to get caught, and prying open can be suppressed. Further, since the edge cover portion 54 is provided along the edge 42e of the main body member 42, the load from the tool T is received by two members, the base material 50 and the main body member 42 when the tool T is inserted for an opening operation. The load can be dispersed more effectively than when the load is received by the main body member 42 alone, and hence the main body member 42 is less likely to be broken. Since the main body member 42 located on the outer side is less likely to be broken, prying open can be further suppressed.

Additionally, since the edge cover portion 54 is provided, the appearance when the 40 is open is improved. In particular, since the surface is inclined, the main body member 42 and the base material 50 are more integrated in appearance, and hence the appearance is further improved.

Secondly, in a first vehicle lid structure, the edge cover portion 54 has the plate-shaped portion 54a including the surface of the edge cover portion 54 and the edge cover portion rib 54d (rib 54d) erected on a rear surface of the plate-shaped portion 54a. The edge cover portion 54 is composed of the plate-shaped portion 54a and the edge cover portion rib 54d. The lid structure can be made lightweight and highly rigid.

In the embodiment, the edge cover portion rib 54d extends from the base end 54f of the plate-shaped portion 54a toward the rear surface 42f of the main body member 42. The base end 54f of the plate-shaped portion 54a is the farthest the rear surface 42f of the tapered plate-shaped portion 54a. Therefore, the edge cover portion rib 54d can be set higher, and the edge cover portion 54 can be reinforced more reliably.

Furthermore, the edge cover portion rib 54d is located between the held portion 43 of the locking mechanism and the main body member 42. Accordingly, it is possible to suppress the loss of load when locking the lid 40 and to smoothly lock the lid 40.

Although the vehicle lid structure according to the invention has been described as being applied to a fuel lid, the vehicle lid structure can also be applied to other devices. Further, the shape of the main body member 42 is not limited to a substantially rectangular shape, but may be any shape such as an ellipse or a circle.

In other words, the invention is not limited to the examples as long as the functions and effects of the invention are achieved.

What is claimed is:

1. A vehicle lid structure comprising:
a main body member that is able to block an opening formed on an exterior surface visible from the outside; and
a base material which supports the main body member and is swingable about a shaft member located behind the exterior surface,
wherein the base material has an edge cover portion which covers an edge of the main body member from the rear side, and
wherein when viewed from a direction along the exterior surface based on a closed state, a surface of the edge cover portion is inclined to approach the opening as it goes from a center of the opening toward an edge of the opening.

2. The vehicle lid structure according to claim 1,
wherein the edge cover portion has a plate-shaped portion which includes the surface of the edge cover portion and a rib which is erected on a rear surface of the plate-shaped portion.
